(19) United States
(12) Patent Application Publication
(10) Pub. No.: US 2011/0307342 A1
(43) Pub. Date: Dec. 15, 2011

(54) METHOD AND SYSTEM FOR GENERATING ELECTRONIC RECEIPTS FROM PRINT DATA

(76) Inventor: Faizal HAJI, Calgary (CA)

(21) Appl. No.: 13/156,599

(22) Filed: Jun. 9, 2011

Related U.S. Application Data
(60) Provisional application No. 61/354,839, filed on Jun. 15, 2010.

(30) Foreign Application Priority Data
Jun. 15, 2010 (CA) 2707929

(51) Int. Cl. G07G 1/12

(52) U.S. Cl. 705/24

(57) ABSTRACT

A Green Receipt Dispenser is a transitional technology that allows a merchant to incorporate paperless receipting functionality into an existing POS system without upgrading or modification to existing software, and without security risk to the merchant or customer. Print traffic is parsed by a processor, the print data is intercepted and converted to an electronic form, and an electronic receipt is provided to the user.

### FIELD OF THE INVENTION

The present invention relates generally to electronic receipting. More particularly, the present invention relates to a method and system for generating electronic receipts directly from print data

### BACKGROUND OF THE INVENTION

The drive to develop paperless transaction systems is generally supported by both merchants and customers. An electronic receipt would typically be easier and more reliable for a customer to manage than a paper receipt, and the electronic record provides a permanent record of a purchase, while minimizing paper waste. Merchants also generally support the concept of electronic receipting to minimize receipt printing costs, and to be seen as innovative and responsive to the needs of their customers.

Point of Sale (POS) systems have been customized to serve specific industries. Accordingly, merchants, hoteliers, and restaurants use POS systems to process purchases by customers and to facilitate electronic record keeping for their business. For example, a merchant may use a POS system to generate accounting reports, employee records, sales reports, track inventory, calculate cost/profit ratios, and the like. The POS system may further be programmed by the merchant to automatically or manually authorize specific discounts, and to authorize returns or exchanges.

A POS system will typically include a main POS terminal/computer and cash drawer, and one or more standard peripheral devices (display monitor, payment processor with pinpad, receipt printer, barcode scanner, weigh scale, electronic signature pad). Customized POS systems may have one or more of these peripheral devices integrated directly into the main POS terminal.

Although POS systems are well equipped for merchants to monitor and collect transaction data from the POS system, the ability of the customer to input or extract useful information from the POS system is typically limited to pinpad interactions (entering tip amounts, obtaining additional cash back, etc.), and obtaining printed receipts, the format and content of which has been pre-determined by the merchant.

While customers may desire electronic receipts rather than a printed copy, the electronic receipting systems suggested to date have proved difficult to incorporate into existing POS systems. The chief difficulty has been security. That is, POS systems are typically sold with an on-board software system that may be specific to the merchant's business. The merchant is able to make minor programming adjustments to add discount codes and other special offers, but has limited ability to add functionality to the POS system. Further, the merchant is typically quite concerned with the integrity of their electronic record keeping system, and is therefore hesitant to allow direct customer interaction with the POS system. For example, a merchant may be unwilling to allow a customer to insert a disk or other storage device into the POS system for fear of compromising the integrity of the POS system. However, a merchant might be more willing to email an electronic receipt to customers.

However, customers tend to resist providing personal information, such as an email address, to a merchant in a public place (at the point of sale), and may also be unwilling to pre-register for electronic receipts from the merchant in advance, particularly if creating an account is required, involving entry of further personal information.

Accordingly, while some POS systems have been described that are capable of providing coded POS data in a customer-specified electronic form, these types of systems are not readily implemented by merchants as it would require customization or replacement of the POS system, and potentially a security risk. Further, many of these systems require users to register in advance, or at the time of purchase, entering personal information into the merchant's system.

Known methods for providing paperless receipts from a POS system rely on the POS system's coded transaction data. That is, for each piece of data stored in the POS system, an identifier is associated with a data value (for example, the POS system associates the identifier “Tax paid” with a particular data/numerical value indicating how much tax was paid, for each transaction). Such transaction data can be used to generate an electronic/paperless receipt using POS system data directly. However, such paperless receipt systems cannot be realized without making modification to existing POS software. As there is no industry standard for the data elements and associated relationship for a POS transaction. Every POS software vendor has its own proprietary set of data elements and relationship for a POS transaction, and these elements and relationships may change between versions of the software, even from the same vendor. Standardizing these elements would be costly. Without standardization, a known paperless receipt system from one vendor cannot be used with POS software from another vendor.

A system in which a merchant may provide electronic receipts to customers without modification to the merchant's POS software, and without requiring customer information to be entered or stored, would be desirable.

### SUMMARY OF THE INVENTION

Generally, a system and is provided for generating electronic receipt files from print data.

In accordance with a first aspect of the invention, there is provided an electronic receipt generator comprising: a processor for installation between a POS system and a paper receipt printer, the processor for intercepting POS print data sent to the paper receipt printer, and converting said print data to an electronic receipt file; and a housing for containing the processor, the housing having an input port through which printer traffic data is received from a POS system and delivered to the processor, and an electronic receipt output port through which an electronic receipt document is subsequently delivered from the processor to a customer.

In one embodiment, the processor comprises a traffic parser for parsing printer traffic to identify and intercepting print data from the printer traffic. The processor may further comprise a text and image converter for converting intercepted print data to one of, or a combination of, text and images. Still further, the processor may comprise a portable document format generator for formatting the intercepted print data to generate a PDF file.

In another embodiment, the processor comprises a receipt printer output port through which printer traffic is delivered to the paper receipt printer. The processor may further comprise a bypass for selectively permitting or preventing transmission of printer traffic to the paper receipt printer.

In some embodiments, the electronic receipt output port may be a USB port or a smartphone docking port.

In accordance with a second aspect of the invention, there is provided an electronic receipt generator comprising a processor for conversion of POS print data to an electronic receipt, the processor having an input port configured to receive print traffic from a printer port of a POS system, and an output port in communication with a storage device, the output port for use in the delivery and storage of the electronic receipt to the storage device; wherein said processor is isolated from the POS system to prevent access to the POS system via the storage device.

In one embodiment, the isolation is a physical isolation in which the processor is physically spaced from the POS system and communicates with the POS system only through receipt of POS system print traffic.

In another embodiment, the isolation is a virtual isolation in which the processor serves as a firewall to prevent communication from the storage device to the POS system.

In accordance with another aspect of the invention, there is provided a method for providing an electronic receipt, the method comprising the steps of: receiving printer traffic from a POS system, the printer traffic comprising print data corresponding to a paper receipt associated with a POS transaction; parsing said print traffic at a processor to identify and intercept print data; converting said intercepted print data to electronic characters to create an electronic receipt file, the electronic receipt file corresponding to said paper receipt; and sending said electronic receipt file from the processor to a storage device specified by a party to the POS transaction.

In one embodiment, the electronic file is a pdf file.

In a further embodiment, the storage device is inserted within a port of the processor.

In various embodiments, the storage device may be one of a memory stick, smartphone, or personal computer.

In an embodiment, the method further comprises the step of delivering said print data to a paper receipt printer.

Other aspects and features of the present invention will become apparent to those ordinarily skilled in the art upon review of the following description of specific embodiments of the invention in conjunction with the accompanying figures

### BRIEF DESCRIPTION OF THE DRAWINGS

Embodiments of the present invention will now be described, by way of example only, with reference to the attached Figures, wherein:

FIG. 1 is a schematic diagram of a system for providing electronic receipts to a customer following a POS transaction, in accordance with one embodiment;

FIG. 2 is a schematic diagram of system function, in one embodiment; and

FIG. 3 is flow diagram depicting a method for intercepting print data and providing an electronic receipt, in one embodiment.

### DETAILED DESCRIPTION

Generally, the present invention provides a method and system for providing electronic receipts using print data generated by a Point of Sale system.

### Overview

The use of print data (instead of POS system transaction data) to generate an electronic receipt allows a customer-centric receipting method without POS system interaction or modification. The system acts as a firewall between the customer and the POS system, facilitating installation continuous with an existing POS system but without permitting customer interaction directly with the POS system.

Generally, most POS systems are compatible with standard receipt printers, for example the ESC/POS® de-facto receipt printer standard developed by Epson Seiko Corporation. Thus, an electronic receipt system as described herein that is capable of capturing and converting print data sent to the aforementioned printer, would also be inter-operable with any POS software that is ESC/POS® compliant. The system can be set up to generate an exact duplicate of the printed receipt, but in electronic form.

To date, software for generating an exact electronic copy of a printed document solely by intercepting and converting print data is unavailable, likely due to the complexity of processing such large volumes of data. Further, doing so in a smart and efficient manner sufficient to enable suitable real-time conversion would generally be considered unfeasible. For most purposes, widely available PDF conversion software (as is resident on most CPUs) and/or document scanners are suitable for generating electronic documents. Due to security purposes, these methods are not suitable for use in the present system.

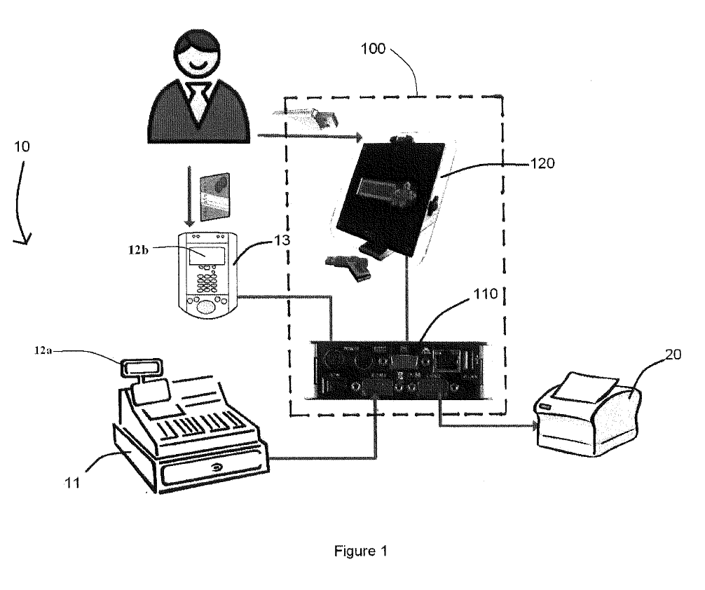

With reference to FIG. 1, an electronic receipting system is shown in which a Green Receipt Dispenser (GRD) system 100, including GRD processor 110 and associated GRD display screen 120, is installed within a POS system 10. The POS system 10 shown generally includes a cash register 11 and display 12a, a customer PIN pad 13 with display 12b, and a receipt printer 20.

As shown in FIG. 1, the PIN pad 13 used by the customer to interact with the POS system is also connected through the GRD processor. This configuration enables the PIN pad to also be used by the customer to interact with the GRD processor. For example, at some point during the transaction, the customer may use the PIN pad to indicate that an electronic receipt and/or paper receipt is desired. It should be noted that this feature (double use of the PIN pad with POS system and with GRD system) is not required, and a separate GRD display and customer interface may be used for this purpose in configurations where the POS PIN pad is not in communication with the GRD processor. Further, in some embodiments, no GRD display or customer input may be necessary, as will be discussed below.

As will be understood from a reading of the present description and review of the Figures, many configurations are possible with respect to the use of peripheral devices. Notably, the GRD processor 100 is installed between the cash register 11 and printer 20 in order to intercept receipt traffic from the print data sent from the POS system to the receipt printer.

Generally, a customer makes a purchase directly with the cashier, using the PIN pad in the customary manner to authorize payment. At some point prior to completing the transaction and having the receipt printed, the customer inserts an electronic storage device into an appropriate port within the GRD system 100. The print data is intercepted by the GRD processor and converted to an electronic form, for example resulting in a PDF document generally corresponding to a paper receipt, that is saved to the customer's storage device. If customer input is required or permitted for the purposes of generating the electronic receipt, the customer interaction is effected via GRD display 120 and PIN pad 13. As the POS portion of the transaction is already complete, customer interaction with the POS system during this portion of the transaction is prevented and the PIN pad 13 communicates only with the GRD processor for the purposes of input relating to the electronic receipt generation.

Accordingly, the customer need not enter any personal information in order to obtain an electronic receipt, and the merchant is also protected as the customer does not interact with the POS system, or obtain transaction data from the POS system.

The term “transaction data” as used herein, refers to POS data that describes the attributes of a purchase using the business language of the merchant. For example, the merchant term “invoice number” identifies a particular data value, for example 52311, which is used by the merchant to identify a particular transaction.

The term “print data” as used herein, refers to data sent to a printer describing the layout of a document, using the page description language of a printer (for example, font type, size, and position on a page). It should be noted that the printer may also receive additional printer traffic from the POS system relating to operation of peripheral devices. For example, a receipt printer may act as a bypass device, handling and redirecting traffic to other devices as appropriate. This type of traffic is not considered to be print data for the purposes discussed herein.

The term “storage device” as used herein refers to any electronic device suitable for receiving an electronic receipt. In a typical embodiment, the storage device is a USB memory stick or smartphone for placement/docking within a port of the GRD system. However, the port may instead be a virtual or wireless connection to a storage device, and the device may be any device containing suitable means for interaction with the GRD processor and having sufficient storage capacity to receive an electronic receipt.

### Green Receipt Dispenser

The Green Receipt Dispenser 100 may be provided as a single multifunction unit (for example, providing a graphical user interface and customer input pad as part of the processor unit), or as a series of co-operating components as shown in FIG. 1. It is also envisioned that in a new POS system installation, the Green Receipt Dispenser could be contained within the POS system housing, while remaining virtually isolated such that the access and exchange of data is not possible other than the printer traffic sent from the POS system to the GRD.

In most configurations, the GRD is a separate device from the POS system, removing the electronic receipting function and customer interaction with this function from the POS system for security purposes. The electronic receipt is not generated by the POS system, but is re-created solely from print data intercepted by the GRD prior to reaching the receipt printer.

### GRD Processor

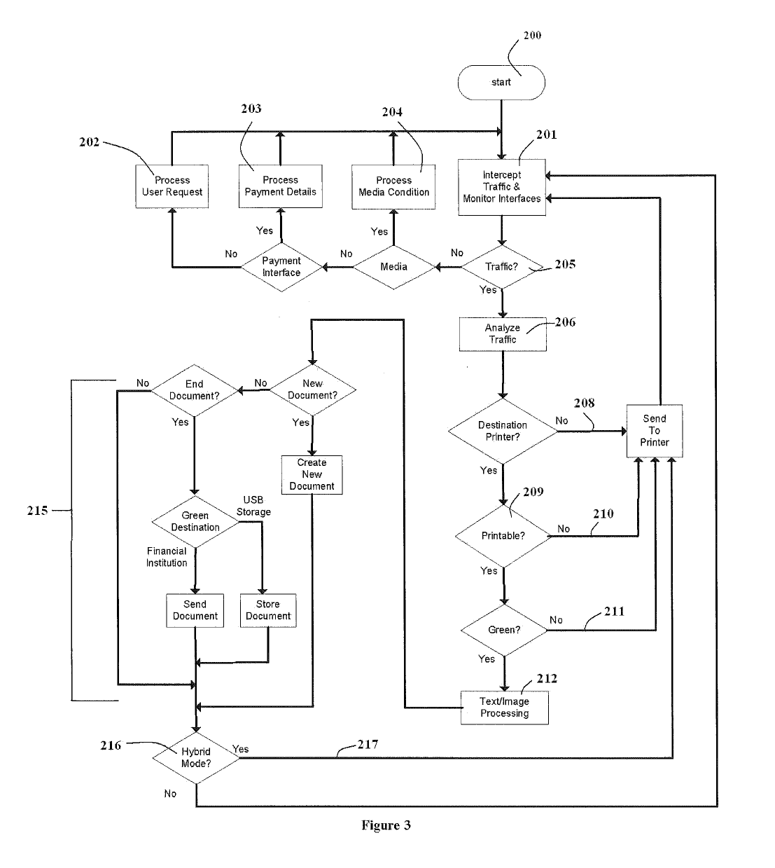

The GRD processor intercepts traffic destined for the receipt printer and re-directs print data for the purpose of generating a paperless receipt, for example in accordance with the method shown in FIG. 3. A soft by-pass switch within the device may be used to re-direct the traffic either to generate a paperless receipt or to the receipt printer, or both, based on customer input to the GRD.

When a USB storage compliant device is to be used to accept a paperless receipt, the customer selects this form of output or simply engages a storage device into an appropriate slot or port in the GRD processor to automatically make the selection.

Notably:

The GRD does not require any new POS software to be installed on the POS terminal.

The GRD does not require the existing POS software on the POS terminal to be modified.

The GRD does not require any new Operating System (OS) to be installed on the POS terminal.

The GRD does not require modification to the currently installed OS on the POS terminal.

The GRD is not dependent on the OS that is installed on the POS terminal.

The GRD does not require any peripheral interface cards to be installed inside the POS terminal.

The GRD functions with existing, for example a ESC/POS® compliant, receipt printer.

The GRD isolates the customer-supplied USB storage from the POS system and hence provides a more secure environment for protecting the merchant's system from malicious software that may be resident on the customer supplied USB storage device.

In some embodiments, the GRD may utilize existing card issuer (financial institution) data on payment cards to forward paperless receipts to financial institutions, if selected by the customer.

The GRD allows the electronic receipt to be generated and provided to the user without requesting and/or storing any customer related information in providing the paperless receipt.

In addition, the GRD may interface with external equipment. For example, the GRD may interface with: a POS terminal via serial, parallel, Ethernet, or USB connection in accordance with ESC/POS® standards; a web browser through TCP/IP connection in accordance with HTTP/1.1, HTML standards; with a receipt printer via serial, parallel, Ethernet, or US connection in accordance with ESC/POS® standards; with a media connector via USBA connection in accordance with USB 2.0 or other USB storage standards, with a payment terminal via serial, USB, or Ethernet connection, and/or with a financial institution network via dialup modem, TCP/IP Ethernet connection in accordance with ISO 8583 standards.

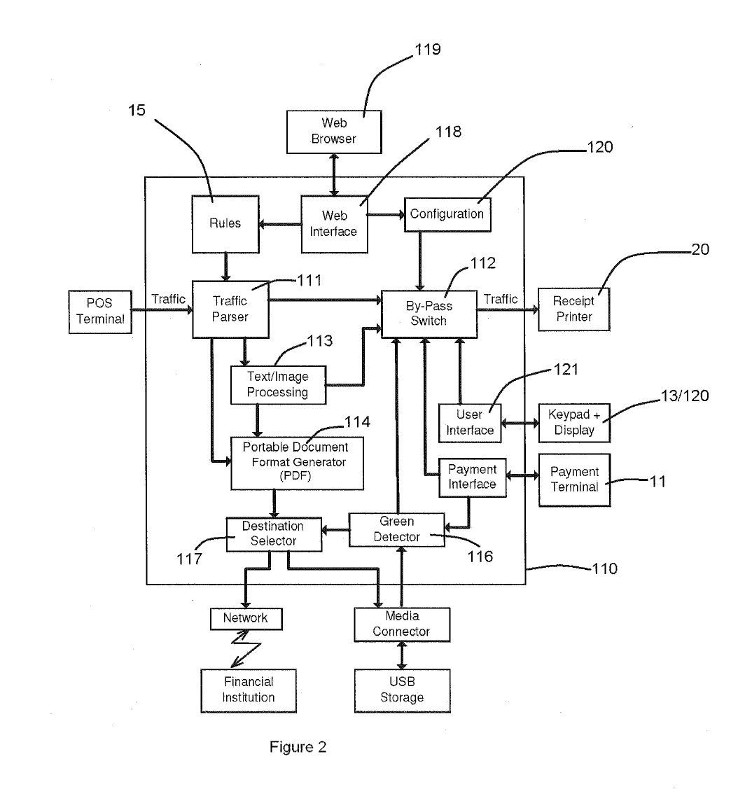

With reference to FIG. 2, a GRD 110 generally includes:

Traffic Parser 111 for analyzing real-time print traffic from the POS system to determine the start, end, and type of receipt indicated by the print traffic,

Bypass Switch 112 for controlling traffic to the paper receipt printer port (for example a ESC/POS® compliant receipt printer),

Text-and-Image Processor 113 for converting intercepted print traffic into electronic text and images,

Portable Document Format generator 114 for formatting the electronic text and images into a PDF file,

Rule Module for use with the traffic parser to identify print data from the printer traffic—this module would typically be merchant-specific, defining associations between keywords present in the intercepted traffic and actions to be taken (for example duplicate copy, coupons, credit card copy, etc.),

Green Detector 116 for detecting user input that an electronic receipt is to be generated (may be a selection by user or may be automatically detected by insertion of USB stick, etc.), and

Destination Selector 117, for delivering the pdf file to the user.

The particular GRD embodiment shown in FIG. 2 also includes:

User Interface 121 for receiving user input and displaying prompts/messages

Web interface 118 with HTTP server, for use in configuring the GRD through a web browser 119, and

Configuration Module 120 for storing the configuration parameters that define the operational characteristics of the GRD (for example the name of the store, the speed at which a file is stored for a particular type of storage device, etc.)

### Method for Generating Electronic Receipts

With reference to FIG. 3, the GRD is activated 200, and is ready to parse print traffic sent from the POS system 11 to the printer 20 (via the GRD processor 100). The processor intercepts 201 any printer traffic and also simultaneously processes any user interface input 202, payment details 203 (whether receipt is to be sent electronically or wirelessly in addition to an on-site physical and/or electronic receipt) and media condition 204 (presence of a storage device).

When printer traffic is detected 205, the traffic is analyzed 206 to determine whether it is print data. If the traffic is not print data, but is otherwise destined for the printer (for example the printer may handle and redirect traffic relating to other devices), the traffic proceeds 208 to the printer.

The traffic is then analyzed 209 to determine whether the data is printable. If the data is not printable, for example it corresponds to a print copy, page cut instruction, or the like, the data is again forwarded 210 to the printer for handling.

If the user has not requested a Green receipt (electronic), the print data is sent 211 to the printer to print a paper receipt. If the user has requested an electronic receipt, either by user request 202 or by placement of a storage device in communication with the GRD processor 204, the print data is processed 212 to electronic text and/or images.

The text/image-processed traffic may initiate a new document, or may be a continuation of a document already being processed. The electronic receipt is further processed according to a series of steps 215 to generate the electronic receipt. The destination for the electronic receipt is detected and the file is stored or otherwise sent accordingly. For example, in FIG. 3, the destination may be USB storage or a financial institution. If hybrid mode 216 is requested or otherwise activated, the print data will also be forwarded 217 back to the printer to print a paper receipt. If no paper receipt is required, the GRD processor intercepts further traffic and no print data is sent to the receipt printer.

When a PDF receipt is stored to a customer device, a standard folder structure is preferably adopted to sort the receipts, as the electronic receipts from various stores may not be readily distinguishable. That is, the GRD may generate a root folder entitled Receipts, and a new sub-folder would be generated each time a new retail store is visited. Within a store folder, additional sub-folders may be generated for each store location, and each store location folder may further be subdivided into cashier/POS station folders.

### Method for Customer Interaction

With reference to the embodiment shown in FIG. 1, when a customer is ready to make a purchase, the customer approaches the cashier and may insert a USB flash drive (commonly known as a memory stick) or other storage device into the media connector on the GRD display to indicate that he/she wishes to receive a paperless receipt. The customer may also optionally select to have a paper-based receipt in addition to the paperless receipt. The selection of the hybrid receipt is done by the customer using the keypad on the GRD customer display (or PIN pad). The GRD can optionally be configured by the merchant to be in either hybrid mode or “electronic receipt only” mode as soon as a storage device is detected. Default configuration to hybrid mode will allow both the store owner and the customer to slowly gain confidence in the paperless receipt concept by having the option of receiving both forms of receipts.

The cashier processes the sales transaction and accepts a form of payment for the sale. With debit and credit card forms of payment and for those customers that do not carry a USB flash drive, the payment terminal can be used by the customer to request a paperless receipt to be forwarded to the financial institution associated with the debit or credit card. The customer may receive a paper receipt from the receipt printer in addition to the paperless receipt. On receipt of payment confirmation, the POS system or cashier finalizes the sale, and the GRD either stores the paperless receipts on the USB flash drive or forwards the paperless receipt to the financial institution identified by the payment card. In hybrid mode, the GRD will also forward the receipt to the receipt printer for printing a paper receipt. The GRD display would then indicate to the customer that the USB flash drive can be safely removed.

The above-described embodiments of the present invention are intended to be examples only, provided for the purpose of assisting the reader in understanding the configuration of the systems discussed herein. Implementations, alterations, modifications and variations may be effected by those of skill in the art upon reading the present disclosure without departing from the scope of the invention, which is defined solely by the claims appended hereto.

What is claimed is:

1. An electronic receipt generator comprising:
a processor for installation between a POS system and a paper receipt printer, the processor for intercepting POS print data sent to the paper receipt printer, and converting said print data to an electronic receipt file,
a housing for containing the processor, the housing having an input port through which printer traffic data is received from a POS system and delivered to the processor, and an electronic receipt output port through which an electronic receipt document is subsequently delivered from the processor to a customer.

2. The electronic receipt generator as in claim 1, wherein the processor comprises a traffic parser for parsing printer traffic to identify and intercepting print data from the printer traffic.

3. The electronic receipt generator as in claim 2, wherein the processor comprises a text and image converter for converting intercepted print data to one of, or a combination of, text and images.

4. The electronic receipt generator as in claim 3, wherein the processor comprises a portable document format generator for formatting the intercepted print data to generate a PDF file.

5. The electronic receipt generator as in claim 1, wherein the housing further comprises a receipt printer output port through which printer traffic is delivered to the paper receipt printer.

6. The electronic receipt generator as in claim 5, wherein the processor further comprises a bypass for selectively permitting or preventing transmission of printer traffic to the paper receipt printer.

7. The electronic receipt generator as in claim 1, wherein the electronic receipt output port is a USB port.

8. The electronic receipt generator as in claim 1, wherein the electronic receipt output port is a smartphone docking port.

9. An electronic receipt generator comprising:
a processor for conversion of POS print data to an electronic receipt, the processor having an input port configured to receive print traffic from a printer port of a POS system, and an output port in communication with a storage device, the output port for use in the delivery and storage of the electronic receipt to the storage device;
wherein said processor is isolated from the POS system to prevent access to the POS system via the storage device.

10. The electronic receipt generator as in claim 9, wherein said isolation is a physical isolation in which the processor is physically spaced from the POS system and communicates with the POS system only through receipt of POS system print traffic.

11. The electronic receipt generator as in claim 9, wherein said isolation is a virtual isolation in which the processor serves as a firewall to prevent communication from the storage device to the POS system.

12. A method for providing an electronic receipt, the method comprising the steps of:
receiving printer traffic from a POS system, the printer traffic comprising print data corresponding to a paper receipt associated with a POS transaction;
parsing said print traffic at a processor to identify and intercept print data;
converting said intercepted print data to electronic characters to create an electronic receipt file, the electronic receipt file corresponding to said paper receipt; and
sending said electronic receipt file from the processor to a storage device specified by a party to the POS transaction.

13. The method as in claim 12, further comprising the step of delivering said print data to a paper receipt printer.

14. The method as in claim 12, wherein the electronic file is a PDF file.

15. The method as in claim 12, wherein the storage device is inserted within a port of the processor.

16. The method as in claim 12, wherein the storage device is one of a memory stick, smartphone, or personal computer.
